(19) United States
(12) Patent Application Publication
(10) Pub. No.: US 2005/0116710 A1
(43) Pub. Date: Jun. 2, 2005

(54) Magnetic resonance imaging

(76) Inventors: Roger John Ordidge, Kent (GB); Andrew N. Priest, Fife (GB); David William Carmichael, Dorset (GB)

Correspondence Address: NIXON & VANDERHYE, PC, 1100 N GLEBE ROAD, 8TH FLOOR, ARLINGTON, VA, 22201-4714, US

(21) Appl. No.: 10/503,342

(22) PCT Filed: Jan. 28, 2003
(86) PCT No.: PCT/GB03/00354

(30) Foreign Application Priority Data
Jan. 31, 2002 (GB) 0202320.8

(51) Int. Cl. G01V 3/00

(52) U.S. Cl. 324/309; 324/307

(57) ABSTRACT

Magnetic resonance images are acquired by combining images obtained using two different spatial sensitivity profiles, 1′, 2′. The transverse magnetisation is caused to adopt such a profile 1′ in one direction, resulting, in two dimensions, to a series of alternating stripes of respectively strong and weak, e.g. zero, transverse magnetisation. The regions of strong transverse magnetisation correspond to regions of high sensitivity in the acquired image. A complementary sensitivity profile 2′ is stored as longitudinal magnetisation. A first image is then acquired in which the pixels are centered on the regions of high sensitivity within the first sensitivity profile 1′. The complementary sensitivity profile 2′ is then recalled by inserting an additional gradient pulse and then a radio-frequency pulse into the pulse sequence and a second image acquired. As with the first image, the pixels are centered on the high-sensitivity regions, but these are mid-way between those within the first sensitivity profile 1′. A combined image is then created by interleaving the two images. The combined image has twice the resolution of each of the two component images. In a further embodiment, two images are acquired in which each spatial sensitivity profile exhibits a sinusoidal profile extending over the field of view. In this case, all the data from the two images are combined using an algorithm.

The present invention relates to magnetic resonance imaging (MRI) and in particular to methods and systems for enhancing the efficiency of such imaging.

In recent times, arrangements have been developed for performing MRI by simultaneously acquiring signals from two or more radio-frequency (RF) surface coils each having a different respective spatial sensitivity response. Normally, an MRI scan is performed using a reduced data matrix, i.e. a reduced coverage of k-space. The resulting images would contain points with signal components from two or more different spatial positions. However, an algorithm, termed a “SENSE” algorithm, has been developed which enables the signals to be combined in such a way that each signal is correctly assigned to a unique spatial position. The SENSE algorithm uses the known spatial profile of each of the RF coils to separate overlapping spatial information into an image of a larger matrix size.

Parallel imaging techniques such as those using the SENSE algorithm cannot be used with only a single receiver coil, since the different responses of two or more coils are required to separate the signals.

One advantage of such an approach is that the scan time is reduced. However, such arrangements suffer from the disadvantage that additional coils, RF electronics and software are required.

It would therefore be desirable to provide improved arrangements which seek to overcome, or at least mitigate, the above disadvantage, while still reducing the scan time. In particular, it would be desirable to provide methods and systems which can be implemented using existing hardware.

In accordance with a first aspect of the present invention there is provided a method of performing magnetic resonance imaging comprising the steps of creating first and second different spatial sensitivity profiles over a given field of view, effecting a first MRI measurement with at least one receiving coil using the first spatial sensitivity profile, effecting a second MRI measurement with the, or at least one of the, receiver coil(s) which as used to effect the first MRI measurement but using the second spatial sensitivity profile and combining the two resulting measurements.

Both measurements are thus effected with the same receiver coil, or with the same array of receiver coils. Therefore, only one receiver coil is required, although more coils may be used if convenient.

With such a method, it will be appreciated that additional coils are not required, since the two different spatial sensitivity profiles are created using the conventional number of coils.

Each of the two spatial sensitivity profiles preferably has alternating regions of relatively high and relatively low sensitivities, the regions of relatively high sensitivity of each profile corresponding to the regions of relatively low sensitivity of the other profile.

In this way, the signals resulting from the two MRI measurements can readily be distinguished.

The two spatial sensitivity profiles may define one or more sensitivity maxima and one or more sensitivity minima, the region or regions having a sensitivity maximum in one of the two profiles corresponding to the region or regions having a sensitivity minimum in the other of the two profiles.

The spatial sensitivity profiles are preferably created by generating corresponding respective spatial distributions of transverse magnetisation prior to MRI image acquisition.

In particular, the first spatial sensitivity profile may be created by generating a corresponding spatial distribution of transverse magnetisation, and the second spatial sensitivity profile may then be created by generating a corresponding spatial distribution of longitudinal magnetisation prior to effecting the first measurement, the spatial distribution of longitudinal magnetisation subsequently being converting to a corresponding spatial distribution of transverse magnetisation prior to effecting the second measurement.

In one of the two cases, the spatial sensitivity profiles may define at least two such sensitivity maxima and at least two such sensitivity minima, and the spacing between adjacent maxima in each profile corresponds to two pixels of the resulting combined MRI image.

Thus, each sensitivity maximum corresponds to a single pixel of the resulting combined MRI image.

Each spatial sensitivity profile preferably exhibits a sinusoidal variation, the two profiles being spatially separated by a phase difference of one quarter-cycle, the sensitivity of the or each sensitivity minimum being preferably substantially zero.

The measurements may simply be combined by interleaving the measurements from the regions of high sensitivity of the two profiles.

Alternatively, the measurements may be combined by performing an algorithm on the measurements taken throughout all of each of the two profiles.

In accordance with a second aspect of the present invention there is provided a system for controlling a magnetic resonance imaging (MRI) apparatus, the system comprising means for selectively establishing first and second modes of operation of the apparatus, each mode defining a different respective spatial sensitivity profile over a given field of view, thereby enabling the MRI apparatus to effect a first measurement at least one receiving coil when the apparatus is operated in the first mode, and subsequently to effect a second measurement using the, or at least one of the, receiving coil(s) which was used to effect the first MRI measurement but when the apparatus is operated in the second mode, said system further comprising means for combining the resulting measurements.

Both measurements are thus effected with the same receiver coil, or with the same array of receiver coils. Therefore, only one receiver coil is required, although more coils may be used if convenient.

Preferred embodiments of the invention will now be described with reference to the accompanying drawings, in which:

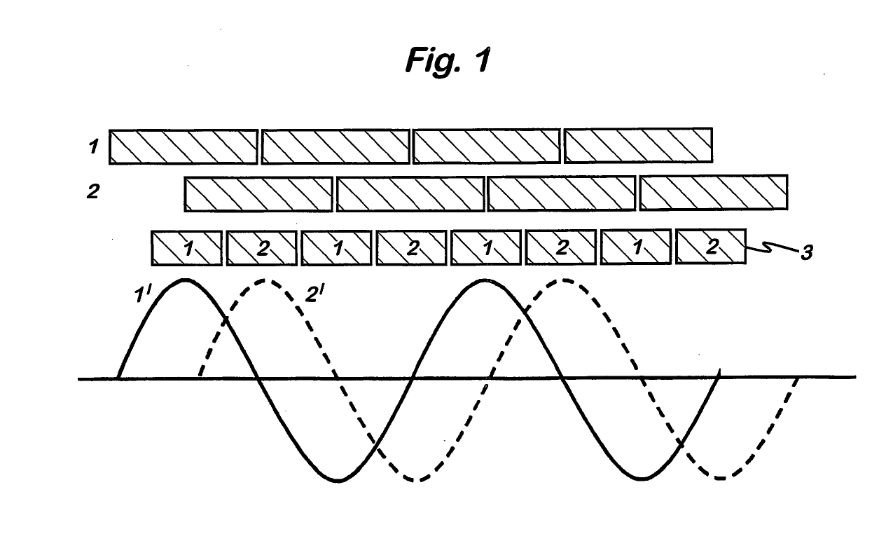

FIG. 1 illustrates the two spatial sensitivity profiles used in a method in accordance with a first embodiment of the present invention;

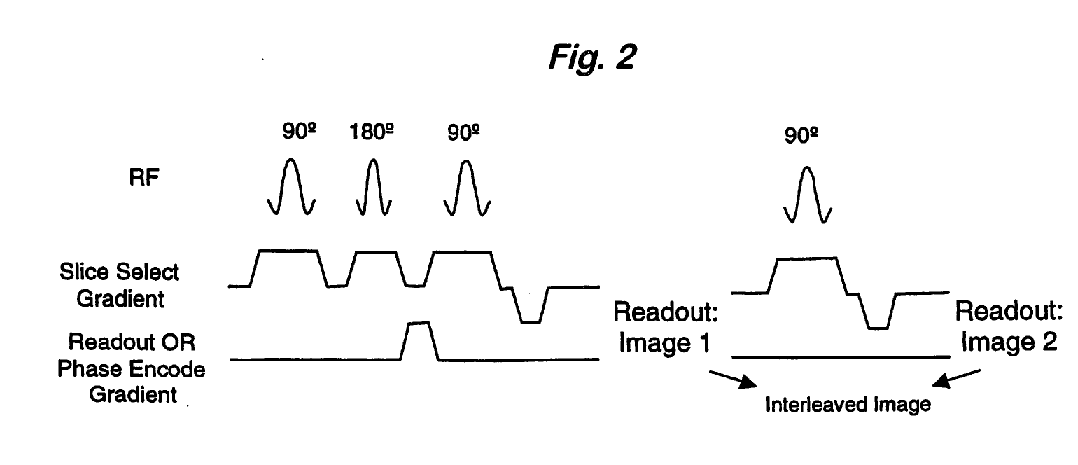

FIG. 2 illustrates the pulse sequence used in methods in accordance with both the first and a second embodiment in accordance with the present invention; and

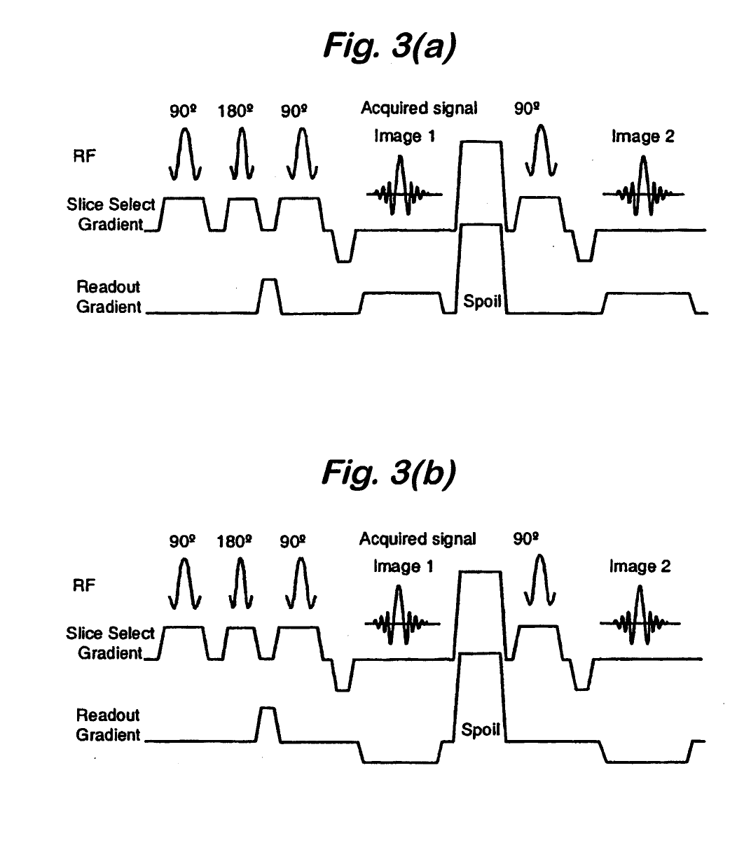

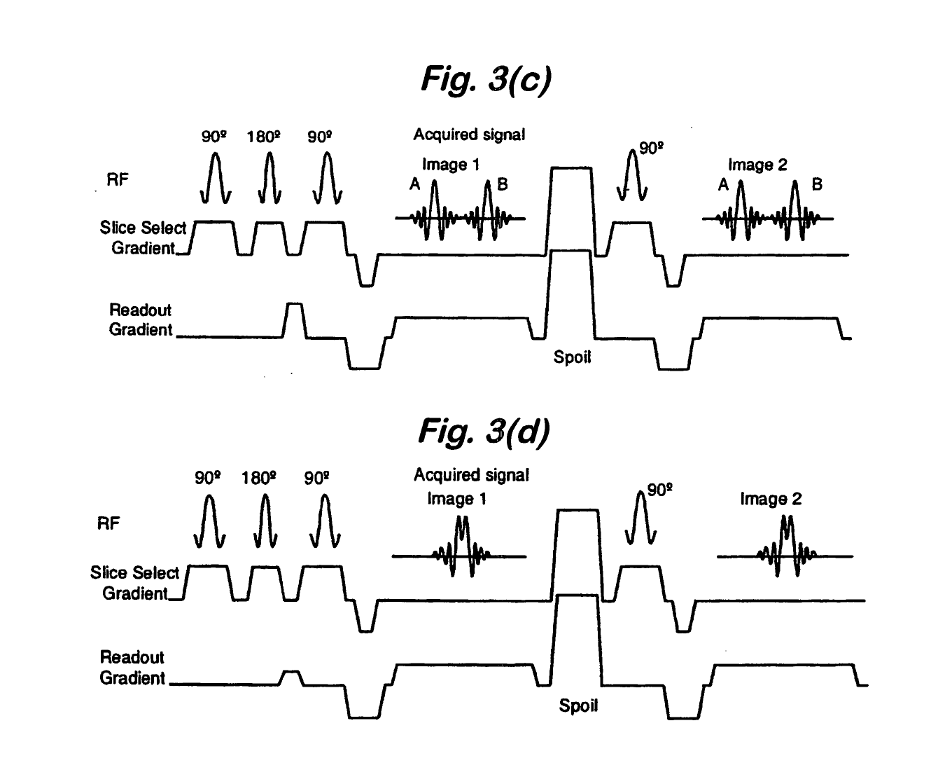

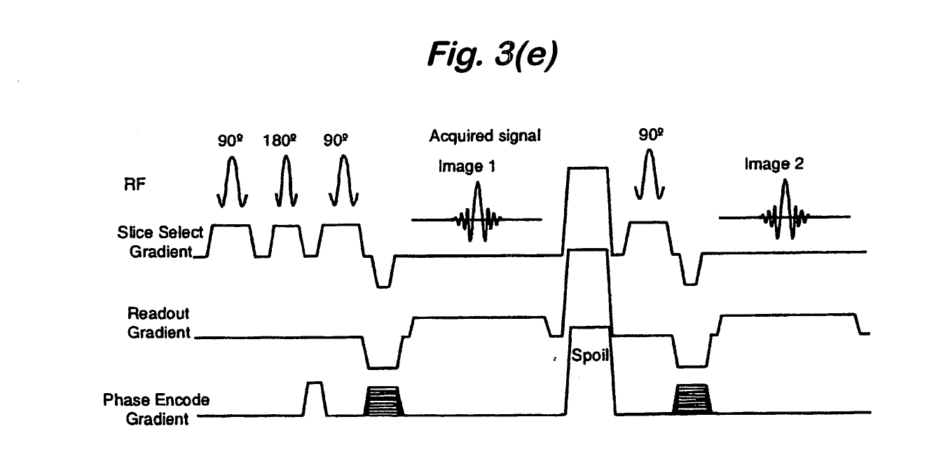

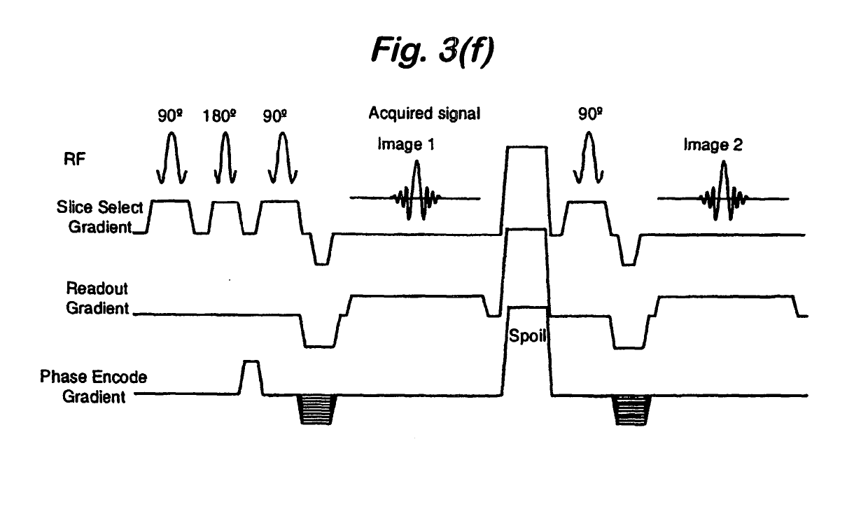

FIG. 3 illustrates four methods of acquiring signals used in the preferred embodiments of the present invention. In particular, FIGS. 3(a), 3(b) and 3(c) relate to the first embodiment, and FIG. 3(d) relates to the second embodiment. FIGS. 3(e) and 3(f) illustrate modes of acquiring signals in accordance with further, alternative embodiments of the present invention.

Magnetic resonance images are acquired from the transverse components of magnetisation, i.e. components perpendicular to the main magnetic field, which is conventionally taken to be along the z-axis. In the preferred embodiments, the resulting image intensities are weighted by a spatial distribution of the transverse magnetisation before an image is acquired. The transverse magnetisation is prepared in the form of a spatial sinusoidal profile extending in one direction, which, in two dimensions, corresponds to a series of alternating stripes of respectively strong and weak, e.g. zero, transverse magnetisation. The regions of strong magnetisation correspond to regions of high sensitivity in the acquired image.

A complementary sensitivity profile is stored as longitudinal magnetisation which is recalled later in the imaging sequence. This is achieved by inserting an additional gradient pulse and then a radio-frequency pulse into the pulse sequence.

In a first embodiment, illustrated in FIG. 1, the spacing between the regions of high sensitivity is set equal to twice the pixel spacing in the final image, and a signal is acquired using a standard MRI readout technique. This signal is used to create an image in which each pixel represents primarily the region of high sensitivity, which is approximately equal to half the area of the pixel. The remaining transverse magnetisation signal is then discarded. The stored longitudinal magnetisation is then converted back to transverse magnetisation by applying a suitable radio-frequency pulse. A second image is then acquired in which the pixels are centred on the regions of high sensitivity within the second sensitivity profile, which are mid-way between those within the first sensitivity profile. A combined image is then created by interleaving the pixels from these two images, and this combined image has twice the resolution of each of the two component images.

FIG. 1 illustrates pixels 1, 2 forming images from the first and second measurements. The shading indicates the parts of the overall sensitivity profile associated with each pixel. The final image 3 comprises the interleaved pixels from the first and second measurements. The solid line 1′ represents the profile of the transverse magnetisation, and the dashed line 2′ represents the profile of the stored longitudinal magnetisation. The profiles can be seen to be sinusoidal in form and separated in phase from each other by one quarter wavelength.

There is a small difference in intensity between the two component images, arising from the decay of the longitudinal magnetisation between the two radio-frequency pulses. However, this is typically substantially less than the decay in the transverse magnetisation which occurs during the signal acquisition.

This technique can be used with any radio-frequency coil arrangement.

The pulse sequence employed is as shown in FIG. 2 and consists of three slice-selective radio-frequency pulses having sequential flip angles of 90°, 180° and 90°. The 180° pulse serves to refocus the magnetisation dephasing resulting from magnetic field inhomogeneities by the time of the second 90° pulse. However, if the degree of magnetisation dephasing is small, this 180° pulse may be omitted and replaced by a refocusing gradient along the slice selection axis.

Between application of the first two 90° pulses, a gradient is applied to partially dephase the magnetisation. Its effect is to create a linear phase shift of the transverse magnetisation. In the rotating reference frame, i.e. a frame rotating about the z-axis, the x- and γ-components of the transverse magnetisation form sine waves in which the maxima are separated by one-quarter wavelength. The effect of the second 90° pulse is to convert one of these two components into longitudinal magnetisation, leaving only one component of transverse magnetisation, the amplitude of which exhibits a positional sinusoidal variation across the image. After the first image is acquired, a third 90° pulse is applied to reconvert this longitudinal magnetisation back to transverse magnetisation, whereupon the second image is acquired, and this is then combined with the first image.

However, the flip angle generated by the RF excitation coil is not always uniform across the object. The technique relies on achieving flip angles that are approximately 90° (and 180°). Where the flip angles have the correct value, the intensities of the first and second images are approximately equal, but elsewhere they may not match correctly. In the interleaved image, this mismatch appears as a set of stripes with a period of two pixels.

To correct for this and related problems, additional pre-scan images are acquired where the phase of the individual RF pulses are altered to determine the size of this error and correct the subsequent images on a pixel-by-pixel basis. This correction also compensates for any small differences that arise as a result of longitudinal (T1) relaxation between acquisition of the first and second images.

The data used for this correction correspond to a measurement of the local distribution of flip angles. Similar corrections could be achieved with any other method of measuring the flip angle distribution.

The amplitude of the gradient is selected so that the wavelength of the sine wave is twice the pixel spacing of each of the first and second acquired images. The distance between regions of peak sensitivity in each image is then one full pixel, with the peaks displaced by one half of a pixel between the first and second acquired images.

The two images are then interleaved to produce a combined image.

In this embodiment, and unusually for MRI, a signal may be acquired using a readout gradient having either a positive or a negative amplitude, following both the second and third 90° pulses. An additional gradient on the readout axis allows the signals from both coherences, A and B, to be measured in the same readout, allowing two separate interleaved images to be produced. The coherences A and B represent the rephasing of signals that have received a similar history of gradients and RF pulses within the experiment.

FIG. 3 illustrates examples of these possible signal acquisition modes after the first 90° pulse in respect of the first image acquisition only, for a simple gradient-echo readout. The phase-encoding gradient is not shown. In mode (a) a positive readout gradient is applied, in mode (b) a negative readout gradient is applied and, in mode (c), two separate interleaved images A and B are reconstructed from the two signals. Mode (d) relates to the second embodiment, described below. The same principles may be applied in the phase encode direction. Modes (e) and (f) give examples of this, corresponding to modes (a) and (b) respectively.

For fast imaging, an echo-planar readout may be used to read the signal from one or both of these coherences. If only one interleaved image is read out, the number of gradient reversals in each readout is reduced by one half, as compared with conventional echo-planar imaging, if the dephasing gradient is applied in the phase-encoding direction.

The above method may be combined with echo-planar imaging (EPI), in order to reduce the EPI readout train length, or to increase the image resolution. This is achieved by applying the sinusoidal profile imposed (a) along the phase-encode direction and (b) along the readout direction. In both cases, two echo-planar readout trains are used, one after the second 90° pulse and one after the third 90° pulse. One relevant issue with EPI is image distortion, which occurs primarily along the phase-encode direction as a result of local changes in the main magnetic field B₀. It has been established, from Jezzard P et al., Magnetic Resonance in Medicine 34:65-73 (1995), that distortion can be corrected with the aid of a map of the magnetic field distribution. Such maps have been obtained, for example, using the phase difference between two images with different echo times, but these may not be ideal if the subject moves between the acquisition of the field map and the image to be corrected.

In case (a), two separate images may be created which have different contrasts as a result of their different effective echo times. Together they can be used to create a B₀ field map, which may be used to correct for the image distortion. Since this field map is measured in a single shot at the same time as the image to be corrected, the distortion correction is much less susceptible to subject motion than most other techniques.

In case (b), two consecutive echoes may be used to encode separate lines of k-space for each gradient reversal of the EPI sequence. This allows k-space to be covered twice as fast in the phase-encode direction, without significant extra demands on the gradient hardware. As in other applications of the above method, first and second images are acquired, which are interleaved (in the readout direction in this case) to form a final image. Compared with conventional EPI, the levels of distortion are reduced by approximately one half.

In a second embodiment, two images are acquired using a similar method to prepare the transverse magnetisation. Each image exhibits a spatial sensitivity profile in the form of a sinusoidal variation in signal intensity and phase in one direction, the two profiles being separated in phase by one-quarter cycle. However, these profiles are not constrained to have maxima or minima associated with specific pixel position.

The method of the second embodiment uses RF-pulses and gradients to obtain multiple images with a unique spatial variation in signal magnitude and/or phase from the object. The multiple images may be taken with a reduction in the amount of Fourier encoding (k-space coverage). This method can be combined with any of the existing parallel imaging procedures. As with such parallel methods, the variation in spatial response can be mapped prior to dynamic scanning and this information used to create a single full image.

As with the first embodiment, these spatial sensitivity profiles are mapped for both component images before image acquisition. Each component image is acquired with a reduced field of view, and the combined image having a full field of view is created by combining the two component images using a “SENSE” algorithm or an equivalent algorithm.

In this embodiment, the wavelength and phase of the magnetisation and intensity in the generated image is not fixed. Thus, the phase of the radio-frequency pulses and the magnitude of the dephasing gradient may be adjusted such that the spatial response gives rise to the optimum signal-to-noise ratio for a given coil or subject to be imaged. When this method is used with echo-planar imaging, the size of the dephasing gradient and the reduction in the field of view may be used to adjust the signal such that two echoes occur within the read-out. These echoes will have different values of T₂*, the time constant which governs the dephasing of the transverse magnetisation, i.e. the return to zero net transverse magnetisation. These two echoes could therefore be used to generate separate images having different values of T₂*.

As with the first embodiment, the pulse sequence employed is as shown in FIG. 2, and the above description of the pulse sequences applies equally to the second embodiment.

However, the amplitude of the gradient is set to be much lower than that used in the first embodiment, and the resulting spatial sinusoidal variation in sensitivity occurs on the scale of the field of view. The resulting two images are combined using a “SENSE” algorithm or an equivalent algorithm.

FIG. 3(d) illustrates the signal acquisition for the second embodiment. The size of the dephasing gradient and the phase of the RF pulses may be varied to manipulate the sensitivity profiles, and the dephasing gradient may be applied along any axis.

In both of the above-described embodiments, an improvement in the signal-to-noise ratio of 2^{0.5} can be achieved with the use of quadrature coils.

In both embodiments, the image contrast may be manipulated and/or further echoes generated, for example by including additional 180° RF pulses in the pulse sequence.

It will be appreciated that there are many advantages of the methods and system of the present invention. As compared with conventional imaging, the readout time and the number of phase-encoding steps are reduced by a factor of up to two. Furthermore, there is no requirement for special coil arrangements for either radio-frequency transmission or the acquisition of sensitivity maps. Furthermore, phase information may be included in the sensitivity maps of the second embodiment to improve the reconstruction procedure. The sequence may be used with any transmit-receive coil that has an acceptable degree of homogeneity, and it can therefore be used easily in a variety of situations. This contrasts with the multiple-coil arrangement of the prior art in which the coil geometry is constrained in relation to its spatial sensitivity profile.

In addition, the variation of sensitivity across an image may be adjusted by changing the magnitude of the dephasing gradient and by adjusting the phase of the radio-frequency pulses in dependence on the object being imaged so as to maximise the signal-to-noise ratio. The signal-to-noise ratio is also enhanced by virtue of the absence of noise correlation between the two component images. Furthermore, the uniformity in signal-to-noise ratio across the images is enhanced, as compared with conventional “SENSE” images, in which the images tend to deteriorate towards the centre of the field of view.

Further benefits which can accrue from the preferred methods and systems of the present invention include a 50% reduction in scan time of echo-planar imaging, 2-dimensional Fourier transform MRI scans and gradient-echo MRI methods. In the case of echo-planar imaging, this results in a reduction of image distortion by one half.

In the second embodiment, fuller use of the magnetic resonance phase information is desirable to obtain the best image quality.

1. A method of performing magnetic resonance imaging (MRI) comprising the steps OF: creating first and second different spatial sensitivity profiles over a given field of view; effecting a first MRI measurement with at least one receiver coil using the first spatial sensitivity profile; effecting a second MRI measurement with the, or at least one of the, receiver coil (s) which was used to effect the first MRI measurement but using the second spatial sensitivity profile; and combining the two resulting measurements.

2. A method as claimed in claim 1, wherein each of the two spatial sensitivity profiles has alternating regions of relatively high and relatively low sensitivities, the regions of relatively high sensitivity of each profile corresponding to the regions of relatively low sensitivity of the other profile.

3. A method as claimed in claim 1, wherein the two spatial sensitivity profiles define one or more sensitivity maxima and one or more sensitivity minima, the region or regions having a sensitivity maximum in one of the two profiles corresponding to the region or regions having a sensitivity minimum in the other of the two profiles.

4. A method as claimed in claim 3, wherein the spatial sensitivity profiles define at least two such sensitivity maxima and at least two such sensitivity minima, and wherein the spacing between adjacent maxima in each profile corresponds to two pixels of the resulting combined MRI image.

5. A method as claimed in claim 1, wherein each of the two spatial sensitivity profiles exhibits a spatial sinusoidal variation, the two profiles being spatially separated by a phase difference of part of a cycle.

6. A method as claimed in claim 3, wherein the sensitivity of the or each sensitivity minimum is substantially zero.

7. A method as claimed in claim 2, wherein the measurements are combined by interlineating the measurements from the regions of high sensitivity of the two profiles.

8. A method as claimed in claim 2, wherein the measurements are combined by performing an algorithm on the measurements taken throughout all of each of the two profiles.

9. A method as claimed in claim 1, wherein the spatial sensitivity profiles are created by generating corresponding respective spatial distributions of transverse magnetisation prior to MRI image acquisition.

10. A method as claimed in claim 9, comprising wherein the first spatial sensitivity profile is created by generating a said corresponding spatial distribution of transverse magnetisation and wherein the second spatial sensitivity profile is created by generating a corresponding spatial distribution of longitudinal magnetisation prior to effecting the first measurement and wherein said spatial distribution of longitudinal magnetisation is subsequently converted to a corresponding spatial distribution of transverse magnetisation prior to effecting the second measurement.

11. A method as claimed in claim 9, wherein the two spatial distributions of transverse magnetisation are created and sampled in two separate MRI image acquisitions.

12. A method as claimed in claim 1, further comprising the steps of manipulating the image contrast and/or generating further images by including additional radio-frequency and gradient pulses.

13. A system for controlling a magnetic resonance imaging (MRI) apparatus, the system comprising means for selectively establishing first and second modes of operation of the apparatus, each mode defining a different respective spatial sensitivity profile over a given field of view, thereby enabling the MRI apparatus to effect a first measurement using at least one receiving coil when the apparatus is operated in the first mode, and subsequently to effect a second measurement using the, or at least one of the, receiving coil (s) which was used to effect the first MRI measurement but when the apparatus is operated in the second mode, said system further comprising means for combining the resulting measurements.

14. A system as claimed in claim 13, wherein each of the two spatial sensitivity profiles has alternating regions of relatively high and relatively low sensitivities, the regions of relatively high sensitivity of each profile corresponding to the regions of relatively low sensitivity of the other profile.

15. A system as claimed in claim 13, wherein the two spatial sensitivity profiles define one or more sensitivity maxima and one or more sensitivity minima, the region or regions having a sensitivity maximum in one of the two profiles having a sensitivity minimum in the other of the two profiles.

16. A system as claimed in claim 15, wherein the spatial sensitivity profiles define at least two such sensitivity maxima and at least two such sensitivity minima, and wherein the spacing between adjacent maxima in each profile corresponds to two pixels of the resulting combined MRI image.

17. A system as claimed in claim 13, wherein each of the two spatial sensitivity profiles exhibits a spatial sinusoidal variation, the two profiles being spatially separated by a phase difference of part of a cycle.

18. A system as claimed in claim 15, wherein the sensitivity of the or each sensitivity minimum is substantially zero. 19. A system as claimed in claim 14, wherein the means for combining the measurements comprises means for interlineating the measurements from the regions of high sensitivity of the two profiles.

20. A system as claimed in claim 14, wherein the means for combining the measurement comprises means for performing an algorithm on the measurements taken throughout all of each of the two profiles.

21. A system as claimed in claim 13, further comprising means for creating said spatial sensitivity profiles by generating corresponding respective spatial distributions of transverse magnetisation prior to MRI image acquisition.

22. A system as claimed in claim 21, wherein said profile-creating means comprises means for generating a said corresponding spatial distribution of transverse magnetisation corresponding to said first mode of operation and means for storing a said spatial distribution corresponding to said second mode of operation in the form of a spatial distribution of longitudinal magnetisation prior to MRI image acquisition in said first mode, means for converting the stored spatial distribution of longitudinal magnetisation into a corresponding spatial distribution of transverse magnetisation prior to MRI image acquisition in said second mode.
